(19) United States
(12) Patent Application Publication
(10) Pub. No.: US 2018/0176885 A1
(43) Pub. Date: Jun. 21, 2018

(54) DELAYING NOTIFICATION DELIVERY BASED ON USER ACTIVITY

(71) Applicant: LENOVO (Singapore) PTE. LTD., New Tech Park (SG)

(72) Inventors: Russell Speight VanBlon, Raleigh, NC (US); John Carl Mese, Cary, NC (US); Nathan J. Peterson, Oxford, NC (US); Arnold S. Weksler, Raleigh, NC (US)

(21) Appl. No.: 15/383,426

(22) Filed: Dec. 19, 2016

(51) Int. Cl. H04W 68/04; H04W 4/02

(52) U.S. Cl. CPC H04W 68/04; H04W 4/02

(57) ABSTRACT

Apparatuses, methods, systems, and program products are disclosed for delaying notification delivery based on user activity. A method includes receiving, by a processor, a notification, determining an activity state of a user intended to receive the notification, and delaying delivery of the notification in response to the activity state of the user being an uninterruptible state.

### FIELD

The subject matter disclosed herein relates to device notifications and more particularly relates to delaying device notifications based on user activity.

### BACKGROUND

Devices such as smart phones, smart watches, tablets, etc. can present notifications to a user to indicate various types of information, such as an incoming phone call, a received text or email message, or the like. However, notifications may be presented at times when the user should not, or does not want to, be distracted.

### BRIEF SUMMARY

An apparatus for delaying notification delivery based on user activity is disclosed. A method and computer program product also perform the functions of the apparatus. In one embodiment, an apparatus includes a processor and a memory that stores code executable by the processor. In certain embodiments, the code is executable by the processor to receive a notification. In a further embodiment, the code is executable by the processor to determine an activity state of a user intended to receive the notification. In some embodiments, the code is executable by the processor to delay delivery of the notification in response to the activity state of the user being an uninterruptible state.

In one embodiment, the code is further executable by the processor to determine a driving condition associated with the user, which defines the user's activity state. In some embodiments, the driving condition is based on a current driving activity being performed by the user. In certain embodiments, the current driving activity is selected from the group consisting of changing lanes, turning, approaching an intersection, approaching a stoplight, parking, and driving in reverse.

In various embodiments, the driving condition is based on one or more driving situations where the user is located. In one embodiment, the one or more driving situations is selected from the group consisting of driving in a school zone, driving in a construction zone, driving in a high-accident area, driving in a low-visibility area, driving in a crowded area, and driving in a high-traffic area.

In some embodiments, the driving condition is based on one or more road conditions where the user is located. In certain embodiments, the one or more road conditions is selected from the group consisting of road construction, dry roads, wet roads, icy roads, snow-packed roads, bumpy roads, and uneven roads. In various embodiments, the code is further executable by the processor to receive input from one or more sensors associated with a vehicle that the user is controlling. In such an embodiment, the driving condition is based on the sensor input.

In one embodiment, the code is further executable by the processor to determine whether the user is actively using one or more applications. The user's activity state may be based on the user's interaction with the one or more applications. In some embodiments, the code is further executable by the processor to determine a physical activity level of the user. The user's activity state may be based on the user's physical activity level.

In a further embodiment, the code is further executable by the processor to determine the user's location. The user's activity state may be based on the user's location. In various embodiments, the notification is associated with one or more of an electronic message and a voice call from a second user. In certain embodiments, the code is further executable by the processor to notify the second user that the user is currently unavailable in response to the user's activity state being an uninterruptible state.

A method, in one embodiment, includes receiving, by a processor, a notification. In a further embodiment, the method includes determining an activity state of a user intended to receive the notification. In some embodiments, the method includes delaying delivery of the notification in response to the activity state of the user being an uninterruptible state.

In one embodiment, the method includes determining a driving condition associated with the user. The driving condition may define the user's activity state. In a further embodiment, the driving condition is based on a current driving activity being performed by the user. The current driving activity may be selected from the group consisting of changing lanes, turning, approaching an intersection, approaching a stoplight, parking, and driving in reverse.

In some embodiments, the driving condition is based on one or more driving situations where the user is located. The one or more driving situations may be selected from the group consisting of driving in a school zone, driving in a construction zone, driving in a high-accident area, driving in a low-visibility area, driving in a crowded area, and driving in a high-traffic area.

In a further embodiment, the driving condition is based on one or more road conditions where the user is located. The one or more road conditions may be selected from the group consisting of road construction, dry roads, wet roads, icy roads, snow-packed roads, bumpy roads, and uneven roads.

A program product, in one embodiment, includes a computer readable storage medium that stores code executable by a processor. In some embodiments, the executable code includes code to perform receiving a notification. In a further embodiment, the executable code includes code to perform determining an activity state of a user intended to receive the notification. In certain embodiments, the executable code includes code to perform delaying delivery of the notification in response to the activity state of the user being an uninterruptible state.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for delaying notification delivery based on user activity;

FIG. 2 is a schematic block diagram illustrating one embodiment of an apparatus for delaying notification delivery based on user activity;

FIG. 3 is a schematic block diagram illustrating one embodiment of another apparatus for delaying notification delivery based on user activity;

FIG. 4 is a schematic flow chart diagram illustrating one embodiment of a method for delaying notification delivery based on user activity; and

FIG. 5 is a schematic flow chart diagram illustrating one embodiment of another method for delaying notification delivery based on user activity.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

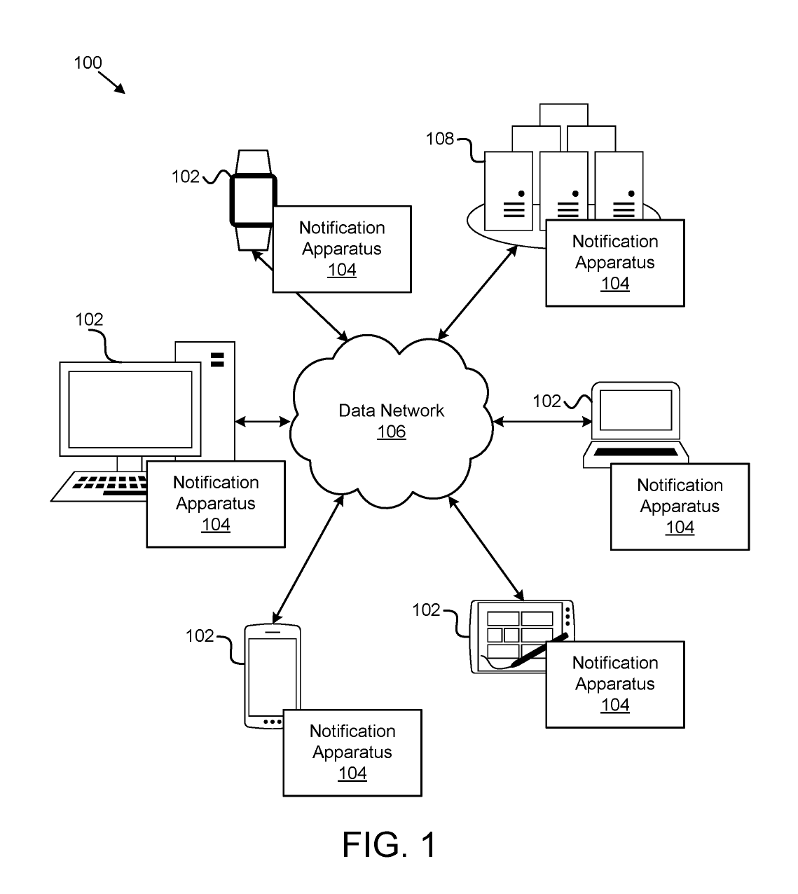

FIG. 1 is a schematic block diagram illustrating one embodiment of a system 100 for delaying notification delivery based on user activity. In one embodiment, the system 100 includes one or more information handling devices 102, one or more notification apparatuses 104, one or more data networks 106, and one or more servers 108. In certain embodiments, even though a specific number of information handling devices 102, notification apparatuses 104, data networks 106, and servers 108 are depicted in FIG. 1, one of skill in the art will recognize, in light of this disclosure, that any number of information handling devices 102, notification apparatuses 104, data networks 106, and servers 108 may be included in the system 100.

In one embodiment, the system 100 includes one or more information handling devices 102. The information handling devices 102 may include one or more of a desktop computer, a laptop computer, a tablet computer, a smart phone, a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium.

In certain embodiments, the information handling devices 102 are communicatively coupled to one or more other information handling devices 102 and/or to one or more servers 108 over a data network 106, described below. The information handling devices 102, in a further embodiment, are configured to execute various programs, program code, applications, instructions, functions, and/or the like, which may access, store, download, upload, and/or the like data located on one or more servers 108. The information handling devices 102 may include one or more sensors for detecting individuals, faces, movements, sounds, vibrations, and/or the like. In some embodiments, the information handling devices 102 include digital cameras for capturing videos and/or still photography.

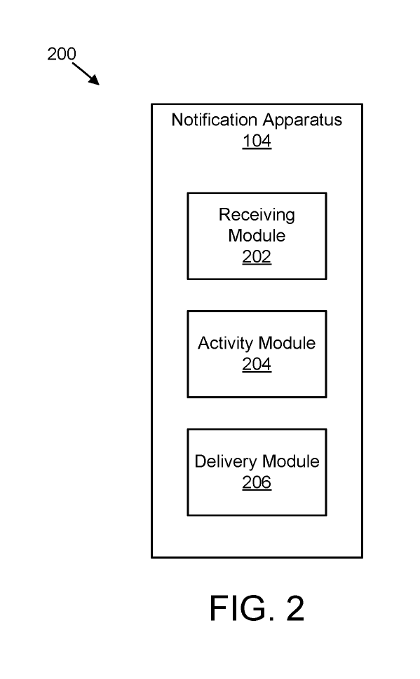

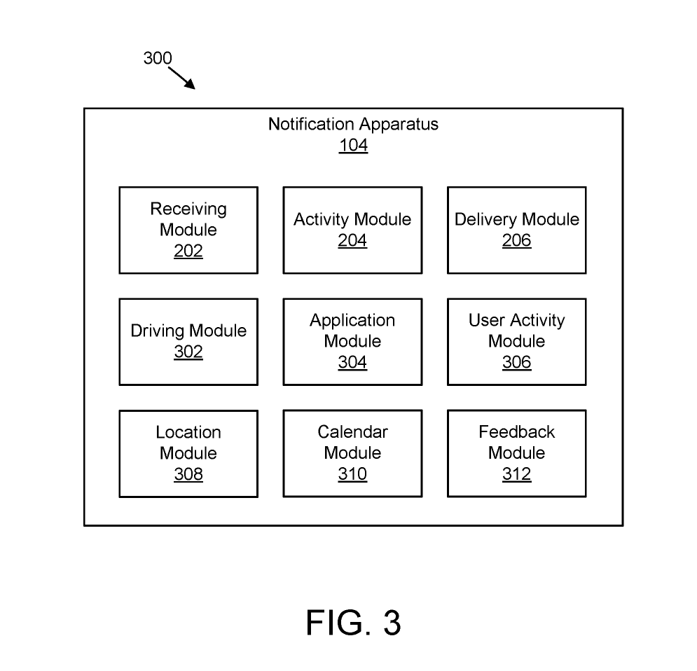

In one embodiment, the notification apparatus 104 is configured to delay delivery of a notification on a device, such as a text message notification, a phone call notification, a push notification for an application, or the like, if the intended recipient of the notification is busy or is performing an activity that cannot or should not be interrupted. In one embodiment, the notification apparatus 104 receives a notification, determines an activity state of the user that is intended to receive the notification, and delays delivery of the notification in response to the activity state of the user being an uninterruptible state. The notification apparatus 104, including its various sub-modules, may be located on one or more information handling devices 102 in the system 100, one or more servers 108, one or more network devices, one or more security systems, and/or the like. The notification apparatus 104 is described in more detail below with reference to FIGS. 2 and 3.

In one embodiment, the notification apparatus 104 improves the safety of using a device by preventing users from becoming distracted when the users are performing actions that they may need to finish, or should finish, before paying attention to their devices. For example, it may be safer, polite, or otherwise necessary for a user to complete an activity related to driving, exercising, reading, attending classes or meetings, or the like before addressing notifications on their devices. The notification apparatus 104, as described below, determines when a user is busy and delays delivery of notifications until the user is no longer busy and can be interrupted.

In various embodiments, the notification apparatus 104 may be embodied as a hardware appliance that can be installed or deployed on an information handling device 102, on a server 108, or elsewhere on the data network 106. In certain embodiments, the notification apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the notification apparatus 104 may include a power interface, a wired and/or wireless network interface, a graphical interface that attaches to a display, and/or a semiconductor integrated circuit device as described below, configured to perform the functions described herein with regard to the notification apparatus 104.

The notification apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the notification apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the notification apparatus 104.

The semiconductor integrated circuit device or other hardware appliance of the notification apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the notification apparatus 104 includes and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (LAN), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (IEEE) 802.11 standards. Alternatively, the wireless connection may be a Bluetooth® connection. In addition, the wireless connection may employ a Radio Frequency Identification (RFID) communication including RFID standards established by the International Organization for Standardization (ISO), the International Electrotechnical Commission (IEC), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (IrPHY) as defined by the Infrared Data Association® (IrDA®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as a mail server, a web server, an application server, an FTP server, a media server, a data server, a web server, a file server, a virtual server, and/or the like. The one or more servers 108 may be communicatively coupled (e.g., networked) over a data network 106 to one or more information handling devices 102. The one or more servers 108 may store data associated with an information handling device 102, with a user, and/or the like.

FIG. 2 is a schematic block diagram illustrating one embodiment of an apparatus 200 for delaying notification delivery based on user activity. In one embodiment, the apparatus 200 includes an embodiment of a notification apparatus 104. The notification apparatus 104, in some embodiments, includes one or more of a receiving module 202, an activity module 204, and a delivery module 206, which are described in more detail below.

The receiving module 202, in one embodiment, receives, creates, or otherwise manages notifications on a device. As used herein, a notification on a device may include a message, a sound, a vibration, a pop-up graphic, and/or the like to notify the user that something on the device needs the user's attention. A notification may be received or created in response to a text message, a phone call, an email, a voicemail, a push notification from an application on the device, and/or the like.

For example, the receiving module 202 may receive or create a notification in response to receiving a text message on a smart phone. The notification may include information about the text message, e.g., who sent it, what time it was sent, the message, or the like. Similarly, the receiving module 202 may receive or create a notification in response to an application, such as a game, a weather application, a driving application, an email application, or the like sending a notification to alert the user that the application needs the user's attention.

The activity module 204, in one embodiment, determines an activity state of the user that is intended to receive the notification. As used herein, the activity state of the user may describe whether the user is in an uninterruptible state or can be interrupted by a notification. In one embodiment, the activity module 204 receives input from one or more sensors associated with the user's device to determine whether the user is busy. For example, the activity module 204 may receive accelerometer data, GPS data, or other motion data to determine that the user is driving, is running/exercising, or the like, as described in more detail below. The activity module 204 may check other indicators of the user's activity state, such as the user's calendar, biometric factors, the user's location, and/or the like.

The activity module 204, in one embodiment, may set an activity flag, bit, or the like to indicate whether the user is interruptible or not based on the user's activity. The activity module 204 may periodically determine the user's activity state and update the activity flag in response to determining a change in the user's activity level. For example, the activity module 204 may determine the user's activity state every second, every 30 seconds, every minute, or the like.

The delivery module 206, in one embodiment, delays delivery of the notification in response to the activity state of the user being an uninterruptible state. In one embodiment, the delivery module 206 checks the activity flag or bit to determine whether the user is in an interruptible state. If the delivery module 206 determines that the user is in an uninterruptible state, the delivery module 206 delays delivery of the notification until the user can be interrupted. For example, if the activity module 204 determines that the user is driving, and is therefore uninterruptible, the delivery module 206 may delay delivery of the notification until the user has parked the car.

The delivery module 206 delays delivery of the notification, in one embodiment, by not presenting the notification on a display of the use's device, by not playing a sound associated with the device, by not vibrating the device, and/or by muting or pausing any other indicators associated with the notification. For example, the delivery module 206 may delay displaying a push notification for an application on the device's display until the activity module 204 determines that the user is in an interruptible state.

FIG. 3 is a schematic block diagram illustrating one embodiment of an apparatus 300 for delaying notification delivery based on user activity. In one embodiment, the apparatus 300 includes an embodiment of a notification apparatus 104. The notification apparatus 104, in some embodiments, includes one or more of a receiving module 202, an activity module 204, and a delivery module 206, which are substantially similar to the receiving module 202, the activity module 204, and the delivery module 206 described above with reference to FIG. 2. In a further embodiment, the notification apparatus 104 includes one or more of a driving module 302, an application module 304, a user activity module 306, a location module 308, a calendar module 310, and a feedback module 312, which are described in more detail below.

The driving module 302, in one embodiment, determines one or more driving conditions associated with the user. If the activity module 204 determines that the user is driving, based on input from one or more sensors, the driving module 302 may determine various driving conditions that may affect the activity state of the user.

In one embodiment, the driving condition is based on a current driving activity that is being performed by the user. For example, the driving module 302 may determine that the user is currently changing lanes; turning at an intersection, stoplight, stop sign, etc.; yielding; approaching an intersection; approaching a stoplight or stop sign; parking; driving on a winding road; parking; driving in reverse; driving in a crowded area; driving up or down a hill; and/or the like.

The driving module 302 may determine the driving activity of the user based on one or more sensors associated with a device (e.g., accelerometer data or other motion data), based on GPS or other location data, based on input from one or more sensors of the vehicle that the user is driving, or the like. For example, the driving module 302 may determine that the user is approaching an intersection or a hill based on location data. In another example, the driving module 302 may determine that the user is changing lines or reversing the vehicle based on the sensors, or other instruments, within the vehicle. In one embodiment, the driving module 302 may communicate with the user's vehicle using a wired (e.g., USB) or wireless (e.g., Bluetooth®) connection.

In a further embodiment, the driving condition is based on one or more driving situations where the user is located. For example, the driving module 302 may use GPS or other location data to determine the user's location, and then the driving module 302 may further determine whether the user is located in a school zone, a construction zone, a high-accident area, an area with low-visibility, a crowded area, a high-traffic area, and/or the like.

In such an embodiment, the driving module 302 may query or check various services to determine the driving situation where the user is located. For example, the driving module 302 may determine that the user is in a school zone based on data received from a mapping service. The driving module 302, in another example, may determine that the user is in a construction zone based on data received from a mapping service or a transportation department. In yet another example, the driving module 302 may determine that the user is in a high-accident or high-traffic area based on data received from a transportation department, from a traffic application (e.g., Waze®), and/or the like.

In one embodiment, the driving condition is based on one or more road conditions where the user is located. For example, the driving module 302 may use GPS or other location data to determine the user's location, and then the driving module 302 may further use data received from a weather service to determine whether the road conditions are dry, icy, wet, snow-packed, or the like at the user's location. The driving module 302 may further determine whether the user is located in a construction zone where the roads are bumpy, have uneven lanes, have narrow lanes, have merging lanes, and/or the like, which may be based on data received from a transportation department, a mapping service, or the like.

Based on the foregoing, if the driving module 302 determines that the user is driving at a location, or under certain circumstances or situations, that may require the user's full attention, the delivery module 206 may delay delivery of a notification until a time when the user is at a state where he can pay attention to the notification without being distracted from other tasks that require his attention.

In one embodiment, the application module 304 determines whether the user is actively using one or more applications on a device. The applications may include a word processing application, an email application, a text application, a browser application, a game, media application, and/or the like. In such an embodiment, if the application module 304 determines that the user is currently using an application, the delivery module 206 may delay delivery of a notification until the user is done using the application or until the user is done with a particular task being performed using the application.

For example, the application module 304 may determine that the user is drafting a text message in a texting application. Accordingly, the activity module 204 may set the user's activity state to uninterruptible or busy, so that the delivery module 206 can delay delivery of the notification, until the application module 304 determines that the user has sent the text message, has closed the text messaging application, has put the device in sleep mode, or the like.

In another example, the application module 304 may determine that the user is listening to music on their phone, and will indicate to the activity module 204 that the user is busy until the song is finished, until the user stops or pauses the song, until the user closes the music application, or the like. In yet another example, the application module 304 may determine that the user is watching a movie or TV program, and will indicate to the activity module 204 that the user is busy until the movie or TV show is finished, until the user stops or pauses the move or TV show, until the user closes the movie/TV application, or the like. In a further example, the application module 304 may determine that a user is playing a game, and will indicate to the activity module 204 that the user is busy until the game is over, until the user stops or pauses the game, until the user closes the game application, or the like. In another example, the application module 304 may determine that the user is talking to one or more different users on the phone, and will indicate to the activity module 204 that the user is busy until the user hangs-up on the call, until the user puts the phone call on mute, until the user closes the phone application, or the like.

In one embodiment, the user activity module 306 determines a physical activity level of the user. For example, the user activity module 306 may determine that the user is just sitting on a couch or is not currently active, which may indicate to the activity module 204 that the user is not busy and can be interrupted by notifications. In some embodiments, the user activity module 306 receives activity data from one or more sensors of a device (e.g., accelerometer data), biometric data (e.g., heart rate data, blood pressure data, etc., from a fitness band or the like), or the like that can indicate an activity level for a user.

Accordingly, if the user activity module 306 determines, based on the activity data, that the user is exercising or performing some other kind of physical activity, the activity module 204 may determine that the user is not in an interruptible state, and that notification delivery should be delayed until the user is finished. In another example, the user activity module 306 may determine that the user is sleeping, based on biometric data, and may indicate to the activity module 204 that the user is busy and should not be bothered with notifications until the user is awake.

In one embodiment, the location module 308 determines the user's location, based on GPS or other location data, and indicates to the activity module 204 whether the user is busy based on the user's location. For example, the location module 308 may determine that the user is located at the user's office at work, and may indicate to the activity module 204 that the user is busy and should not be distracted with notifications until the user leaves work. Other locations may include the gym, at school, at a sporting event or a concert, at the hospital, at church, at home, or the like.

In one embodiment, the calendar module 310 checks a user's calendar, e.g., a calendar on the user's device, a calendar hosted in the cloud, or the like, to determine whether the user is currently active. For example, the calendar module 310 may determine that the user has a meeting schedules, and may indicate to the activity module 204 that the user will be busy during the time period that the meeting is scheduled, and therefore should not be distracted with any notifications. When the meeting time begins, the activity module 204 may also check with the location module 308 to determine the user's location to confirm that the user is located at the location where the meeting is scheduled. If so, then the delivery module 206 may delay delivery of notifications until the user is no longer located at the meeting location or until the scheduled meeting time has expired. Other calendar events may include sporting events, church, school events, lunch meetings, etc.

The feedback module 312, in one embodiment, notifies a second user associated with the notification that the intended user is currently unavailable. For example, if the second user calls the intended user, or sends the intended user a text message, if the activity module 204 determines that the intended user is busy and cannot be interrupted, the feedback module 312 may send a message or provide some other kind of feedback to the second user to indicate that the intended user is currently unavailable.

In some embodiments, the activity module 204 allows a user to specify preferences that indicate when, where, and/or under what circumstances notification should be delayed or should be immediately presented to the user. For example, the user may specify that notifications should be received while driving under certain circumstances, such as when roads conditions are dry, but not when road conditions are snowy or wet. In another example, the user may specify that notification should be received when in certain types of meetings, but not others, and so on.

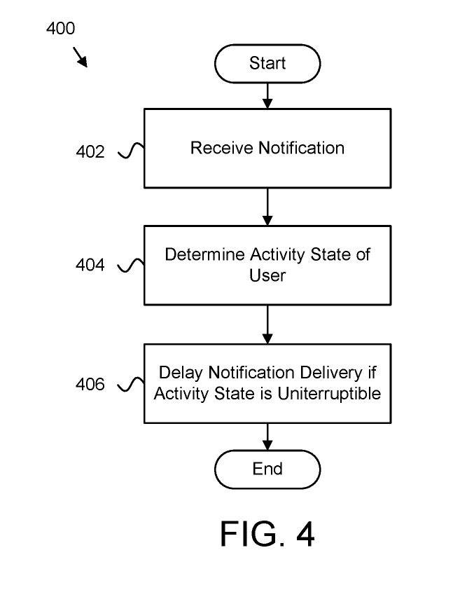

FIG. 4 is a schematic flow chart diagram illustrating one embodiment of a method 400 for delaying notification delivery based on user activity. In one embodiment, the method 400 begins and receives 402 a notification for an intended user. The method 400, in a further embodiment, determines 404 an activity state of the user that is intended to receive the notification. In some embodiments, the method 400 delays 406 delivery of the notification in response to the activity state of the user being an uninterruptible state, and the method 400 ends. In one embodiment, the receiving module 202, the activity module 204, and the delivery module 206 performs the various steps of the method 400.

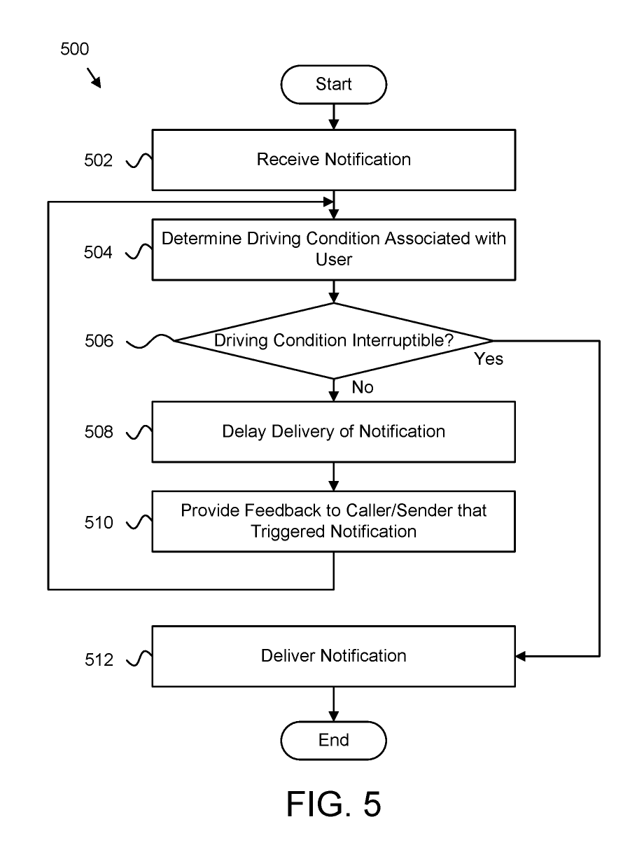

FIG. 5 is a schematic flow chart diagram illustrating one embodiment of another method 500 for delaying notification delivery based on user activity. In one embodiment, the method 500 begins and receives 502 a notification for an intended user. In a further embodiment, the driving module 302 determines 504 one or more driving conditions associated with the user, such as driving activities that the user is performing, driving situations that the user may find himself in, road conditions that the user is driving in, and/or the like.

In one embodiment, the method 500 determines 506 whether the driving condition is interruptible. If it is, the method 500 delivers 512 the notification, and the method 500 ends. Otherwise, in some embodiments, the method 500 delays 508 delivery of the notification. The method 500, in certain embodiments, provides 510 feedback to the caller/sender that triggered the notification indicating the intended user is unavailable. The method 500 then, in some embodiments, continues to determine 506 whether the driving condition is interruptible until the user becomes available. In which case, the method 500 delivers 512 the notification, and the method 500 ends. In one embodiment, the receiving module 202, the activity module 204, the delivery module 206, and the driving module 302 perform the various steps of the method 500.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
an information handling device;
a processor for the information handling device; and
a memory that stores code executable by the processor to:
receive a notification at the information handling device;
determine that a user is interacting directly with an application executing on the information handling device, an activity state of the user comprising an uninterruptible state while the user directly uses the application; and
delay delivery of the notification on the information handling device until the user is in an interruptible state, the interruptible state set in response to the user performing an action directly within the application that indicates that the user is in an interruptible state, the action indicating completion of a particular task performed within the application.

2. The apparatus of claim 1, wherein the code is further executable by the processor to determine a driving condition associated with the user, the driving condition further defining the user's activity state.

3. The apparatus of claim 2, wherein the driving condition is based on a current driving activity being performed by the user.

4. The apparatus of claim 3, wherein the current driving activity is selected from the group consisting of changing lanes, turning, approaching an intersection, approaching a stoplight, parking, and driving in reverse.

5. The apparatus of claim 2, wherein the driving condition is based on one or more driving situations where the user is located.

6. The apparatus of claim 5, wherein the one or more driving situations is selected from the group consisting of driving in a school zone, driving in a high-accident area, driving in a low-visibility area, driving in a crowded area, and driving in a high-traffic area.

7. The apparatus of claim 2, wherein the driving condition is based on one or more road conditions where the user is located.

8. The apparatus of claim 7, wherein the one or more road conditions is selected from the group consisting of road construction, dry roads, wet roads, icy roads, snow-packed roads, bumpy roads, and uneven roads.

9. The apparatus of claim 2, wherein the code is further executable by the processor to receive input from one or more sensors associated with a vehicle that the user is controlling, the driving condition based on the sensor input.

10. (canceled)

11. The apparatus of claim 1, wherein the code is further executable by the processor to determine a physical activity level of the user, the user's activity state based on the user's physical activity level.

12. The apparatus of claim 1, wherein the code is further executable by the processor to determine the user's location, the user's activity state based on the user's location.

13. The apparatus of claim 1, wherein the notification is associated with one or more of an electronic message and a voice call from a second user.

14. The apparatus of claim 13, wherein the code is further executable by the processor to notify the second user that the user is currently unavailable in response to the user's activity state being an uninterruptible state.

15. A method comprising:
receiving, by a processor of an information handling device, a notification at the information handling device;
determining that a user is interacting directly with an application executing on the information handling device, an activity state of the user comprising an uninterruptible state while the user directly uses the application; and
delaying delivery of the notification on the information handling device until the user is in an interruptible state, the interruptible state set in response to the user performing an action directly within the application that indicates that the user is in an interruptible state, the action indicating completion of a particular task performed within the application.

16. The method of claim 15, further comprising determining a driving condition associated with the user, the driving condition further defining the user's activity state.

17. The method of claim 16, wherein the driving condition is based on a current driving activity being performed by the user, the current driving activity selected from the group consisting of changing lanes, turning, approaching an intersection, approaching a stoplight, parking, and driving in reverse.

18. The method of claim 16, wherein the driving condition is based on one or more driving situations where the user is located, the one or more driving situations selected from the group consisting of driving in a school zone, driving in a high-accident area, driving in a low-visibility area, driving in a crowded area, and driving in a high-traffic area.

19. The method of claim 16, wherein the driving condition is based on one or more road conditions where the user is located, the one or more road conditions selected from the group consisting of road construction, dry roads, wet roads, icy roads, snow-packed roads, bumpy roads, and uneven roads.

20. A program product comprising a non-transitory computer readable storage medium that stores code executable by a processor, the executable code comprising code to perform:
receiving a notification at an information handling device;
determine that a user is interacting directly with an application executing on the information handling device, an activity state of the user comprising an uninterruptible state while the user directly uses the application; and
delaying delivery of the notification on the information handling device until the user is in an interruptible state, the interruptible state set in response to the user performing an action directly within the application that indicates that the user is in an interruptible state, the action indicating completion of a particular task performed within the application.
